(19) United States
(12) Patent Application Publication
(10) Pub. No.: US 2025/0133560 A1
(43) Pub. Date: Apr. 24, 2025

(54) DATA TRANSMISSION METHOD AND COMMUNICATION DEVICE

(71) Applicant: INSTITUTE FOR INFORMATION INDUSTRY, TAIPEI (TW)

(72) Inventor: Yen-Chih KUO, TAIPEI (TW)

(21) Appl. No.: 18/515,308

(22) Filed: Nov. 21, 2023

(30) Foreign Application Priority Data
Oct. 20, 2023 (TW) 112140284

(51) Int. Cl. H04W 72/1268; H04W 72/0446; H04W 72/50

(52) U.S. Cl. CPC H04W 72/1268; H04W 72/0446; H04W 72/50

(57) ABSTRACT

A data transmission method suitable for a communication device is disclosed. The communication device is communicatively connected to a base station. The data transmission method includes the following steps: receiving a configured grant from the base station, in which the configure grant is used for scheduling a periodical resource, and the periodical resource is used for transmitting data to the base station; transmitting the first part of the data and a first request indication to the base station through the periodical resource, in which the first request indication is used for requesting a first additional resource from the base station; and detecting the first additional resource is obtained before transmitting the second part of the data through the periodical resource, and transmitting the second part of the data to the base station through the first additional resource, in response to obtaining the first additional resource.

### CROSS-REFERENCE TO RELATED APPLICATION

This application claims the priority benefit of TAIWAN application serial no. 112140284, filed Oct. 20, 2023, the full disclosure of which is incorporated herein by reference.

### BACKGROUND

### Field of Invention

The invention relates to a data transmission method and a communication device. More particularly, the invention relates to a data transmission method and a communication device for transmitting extended reality (XR) data.

### Description of Related Art

With the vigorous development of immersive experience technology (e.g., XR), the demand for high image quality and low latency has increased rapidly. The uplink data transmission of the wireless communication faces the challenge of transmitting new data types. The new data types include periodical data with large amount of data and large changes and network jitter.

The current uplink schedule is divided into configured grant and dynamic grant. The configured grant refers to performing uplink transmission with pre-configured periodic resource, so as to transmit uplink periodical data with small data volume and variation, and to avoid complicated signaling exchanging. Dynamic grant refers to performing uplink transmission with precise resource allocation and flexible resource scheduling, so as to transmit uplink non-periodic data with large data changes.

However, the resource size and resource allocation period of the configured grant are fixed. If the allocated resource is insufficient, part of the data is delayed transmitted. If the allocated resource is redundant, the resource will be wasted. If data arrives earlier than the resource, the transmission delay will occur, and if the data arrives later than the resource, part of the resource will be delayed transmitted.

On the other hand, the transmission method of dynamic grant requires more message exchanges (e.g., buffer status report), which is difficult to achieve the requirement of low latency, and resource may be wasted due to too many resources are requested according to the buffer status report.

Therefore, how to enhance the technology of resource scheduling for the uplink transmission so as to face new data types, and how to improve transmission resource utilization and the flexibility of the uplink schedule usage, so as to meet the requirements of high image quality and low latency, is one of the problems to be solve in this field.

### SUMMARY

Therefore, the embodiments of the present disclosure provide a data transmission method and a communication device that solves the above problems, so as to enhance the technology of resource scheduling for uplink transmission for facing new data types, to improve the utilization of the transmission resource and the uplink schedule usage flexibility, and to meet high image quality and low latency requirements.

An aspect of this disclosure is to provide a data transmission method. The data transmission method is suitable for a communication device. The communication device is communicatively connected to a base station. The data transmission method includes the following steps: receiving a configured grant from the base station, wherein the configured grant is used for scheduling a periodical resource, wherein the periodical resource is used for transmitting a data to the base station; transmitting a first part of the data and a first request indication to the base station through the periodical resource, wherein the first request indication is used for requesting a first additional resource from the base station; and detecting that the first additional resource is obtained before transmitting a second part of the data through the periodical resource, and transmitting the second part of the data to the base station through the first additional resource, in response to obtaining the first additional resource.

Another aspect of this disclosure is to provide a communication device. The communication device includes a storage circuit and a processor. The storage circuit is configured to store several commands. The processor is coupled to the storage circuit, and the processor is configured to execute the commands to perform the following steps: receiving a configured grant from the base station, wherein the configured grant is used for scheduling a periodical resource, wherein the periodical resource is used for transmitting a data to the base station; transmitting a first part of the data and a first request indication to the base station through the periodical resource, wherein the first request indication is used for requesting a first additional resource from the base station; and detecting that the first additional resource is obtained before transmitting a second part of the data through the periodical resource, and transmitting the second part of the data to the base station through the first additional resource, in response to obtaining the first additional resource.

According to the above, the embodiments of the present disclosure provide a data transmission method and a communication device. In the face of a large increase in uplink data with XR, before transmitting the periodic data with large data changes or data with changing arrival time to the base station through the periodical resource of the configured grant, the additional resource is dynamically requested. For example, the embodiments of the present disclosure generate request indication and transmit the request indication while transmitting data to the base station through the periodical resource of the configured grant, which can reduce the signal exchange between the base station and the communication device, thereby improving the resource utilization between the base station and the communication device. In addition, by transmitting data through additional resource, the flexibility of resource allocation can be increased, and the resource waste can be reduced, thereby improving resource utilization and achieving better resource usage efficiency.

### BRIEF DESCRIPTION OF THE DRAWINGS

Aspects of the present disclosure are best understood from the following detailed description when read with the accompanying figures. It is noted that, according to the standard practice in the industry, various features are not drawn to scale. In fact, the dimensions of the various features may be arbitrarily increased or reduced for clarity of discussion.

FIG. 1 is a schematic diagram illustrating an operation of a wireless communication system according to some embodiments of the present disclosure.

FIG. 2 is a schematic diagram illustrating a communication device according to some embodiments of the present disclosure.

FIG. 3 is a flow chart illustrating a data transmission method according to some embodiments of the present disclosure.

FIG. 4 is a schematic diagram illustrating a data transmission situation according to some embodiments of the present disclosure.

FIG. 5 is a schematic diagram illustrating a data transmission situation according to some embodiments of the present disclosure.

FIG. 6 is a schematic diagram illustrating a data transmission situation according to some embodiments of the present disclosure.

FIG. 7 is a schematic diagram illustrating a data transmission situation according to some embodiments of the present disclosure; and

FIG. 8 is a schematic diagram illustrating a data transmission situation according to some embodiments of the present disclosure.

### DETAILED DESCRIPTION

The following disclosure provides many different embodiments, or examples, for implementing different features of the invention. Specific examples of components and arrangements are described below to simplify the present disclosure. These are, of course, merely examples and are not intended to be limiting. In addition, the present disclosure may repeat reference numerals and/or letters in the various examples. This repetition is for the purpose of simplicity and clarity and does not in itself dictate a relationship between the various embodiments and/or configurations discussed. The operations of “determine” or “obtain” used in this article may be replaced by operations including “generate” or “compute”.

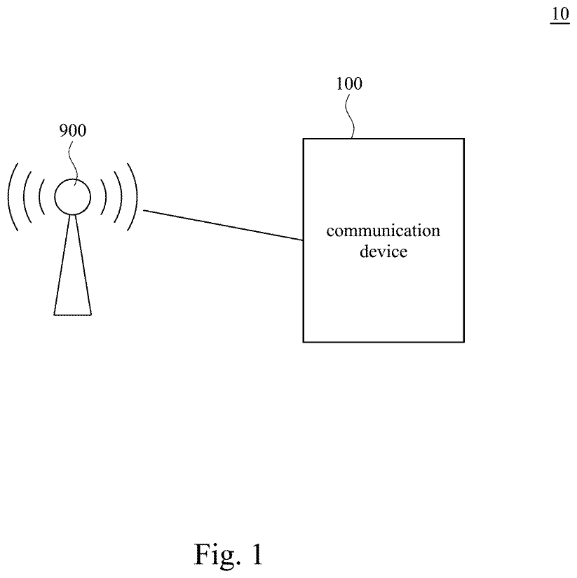

Reference is made to FIG. 1. FIG. 1 is a schematic diagram illustrating an operation of a wireless communication system 10 according to some embodiments of the present disclosure. In some embodiments, the wireless communication system 10 may be a fifth-generation mobile communication system (hereinafter referred to as 5G), beyond 5G, a sixth generation (6G) mobile communication system and/or other similar wireless communication system (e.g., the evolution of any of the above systems). The wireless communication system 10 may include a network terminal and the communication device 100. The network terminal may include a base station 900 (only base station is illustrated for simplicity). The communication device 100 may be user equipment (UE) or other electronic devices with similar functions. The communication device 100 is communicatively connected to the base station 900.

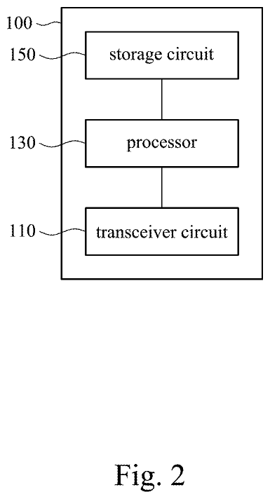

Reference is made to FIG. 2. FIG. 2 is a schematic diagram illustrating a communication device 100 according to some embodiments of the present disclosure. The communication device 100 includes a storage circuit 110, a processor 130 and a transceiver circuit 150.

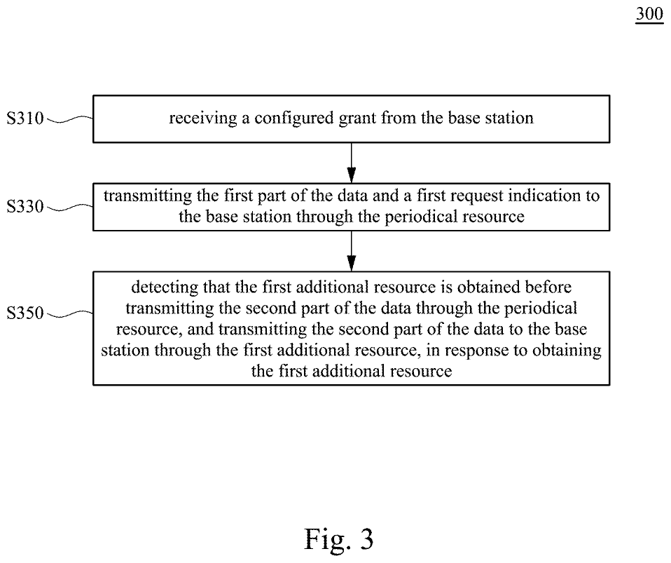

In the connection relationship, the storage circuit 110 is coupled to the processor 130, and the processor 130 is coupled to the transceiver circuit 150. The detailed operation method of the communication device 100 in FIG. 1 and FIG. 2 will be explained together with FIG. 3 below.

Reference is made to FIG. 3 together. FIG. 3 is a flow chart illustrating a data transmission method 300 according to some embodiments of the present disclosure.

The data transmission method 300 can be applied to system with the same or similar structure as the communication device 100 in FIG. 1 and FIG. 2. To make the description simple, the following will take FIG. 1 and FIG. 2 as examples to describe the operation method, but the embodiments of the present disclosure are not limited to the application of FIG. 1 and FIG. 2.

It should be noted that, in some embodiments, the data transmission method 300 can also be implemented as computer program(s) or instruction(s), and stores in a storage circuit 110 as illustrated in FIG. 2, so that the processor 130 of the communication device 100 in FIG. 2 can perform this operation method after reading the computer program(s) or the instruction(s). The processor 130 may include one or more chips. The storage circuit 110 can be read-only memory, flash memory, floppy disks, hard disks, optical disks, flash drives, tapes, databases that can be accessed over the Internet, or a non-transitory computer with the same function can read the recording medium those who are familiar with this technology can easily think of.

In addition, it should be noted that the operations of the data transmission method 300 mentioned in this embodiment can be adjusted according to actual needs and can even be performed at the same time or partly, unless the order is specifically stated.

Furthermore, in different embodiments, these operations may also be adaptively added, replaced, and/or omitted.

Reference is made to FIG. 3. The data transmission method 300 includes the following steps S310 to S350. In step S310, the configured grant is received from the base station (e.g., the base station 900 in FIG. 1). The configured grant is used for scheduling a periodical resource. The periodical resource is used for transmitting data to base station. In step S330, the first part of the data and a first request indication are transmitted to the base station through the periodical resource, in which the first request indication is used for requesting a first additional resource from the base station. In step S350, it is detected that the first additional resource is obtained before transmitting the second part of the data through the periodical resource, and the second part of the data is transmitted to the base station through the first additional resource, in response to obtaining the first additional resource. The above data transmission method 300 faces a large increase in the uplink data of XR. For periodical data with large data changes or for data with changing arrival time, before transmitting data to the base station through the periodical resource of the configured grant, the request indication is generated and the request indication is transmitted at the same time as the data is transmitted to the base station through the periodical resource of the configured grant. It can reduce the signal exchange between the base station and the communication device, thereby improving the resource utilization between the base station and the communication device. Details of the data transmission method 300 will be explained below with reference to FIG. 1 and FIG. 2.

In some embodiments, the processor 130 of the communication device 100 as illustrated in FIG. 2 receive configured grant from the base station 900 through the transceiver circuit 150.

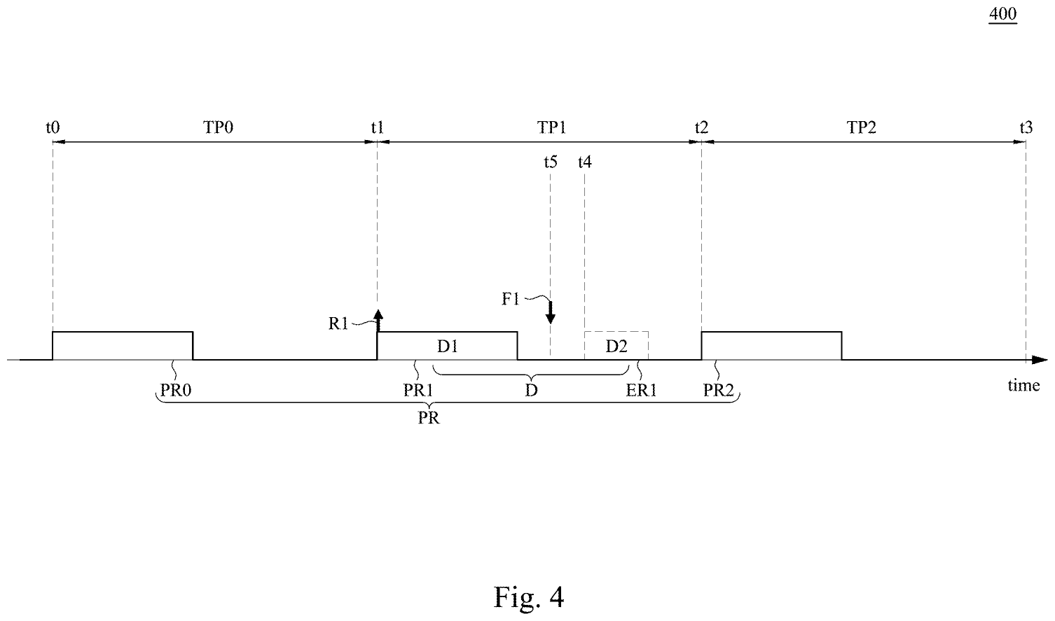

FIG. 4 is a schematic diagram illustrating a data transmission situation 400 according to some embodiments of the present disclosure.

The periodical resource PR as illustrated in FIG. 4 is a periodical resource. The periodical resource PR is the resource scheduled to the communication device 100 by the base station 900 through configured grant. As illustrated in FIG. 4, the periodical resource PR includes the period PR0, the period PR1 and the period PR2. The arrival time of the period PR0 of the periodical resource PR is the time point to, the arrival time of the period PR1 of the periodical resource PR is the time point t1, and the arrival time of the period PR2 of the periodical resource PR is the time point t2. From the arrival time of the period PR0 of the periodical resource PR to the arrival time of the period PR1 of the periodical resource PR is the time period TP0, and from the arrival time of the period PR1 of the periodical resource PR to the arrival time of the period PR2 of the periodical resource PR is the time period TP1, and so on.

The periodical resource PR can include more periods. For convenience of illustration and explanation, only periods PR0 to PR2 are shown in FIG. 4. However, more periods are also within the embodiments of the present disclosure.

Through the periodical resource PR, the communication device 100 shown in FIG. 1 can uplink transmit data to the base station 900.

Reference is made to FIG. 3 again. In some embodiments, the step S330 is operated by the processor 130 in FIG. 2.

Reference is made to FIG. 4 together. In some embodiments, in period PR1 of the periodical resource PR, the processor 130 transmits part D1 of the data D and the request indication R1 to the base station 900. The request indication R1 is used for requesting the additional resource ER1 from the base station 900.

In some embodiments, the data D includes the XR data.

In some embodiments, before performing step S330, the processor 130 first compares whether the data length of data D is greater than the transmittable data length of the period PR1 of the periodical resource PR. When the data length of the data D is greater than the transmittable data length of the period PR1 of the periodic resource PR, since the data D cannot be transmitted completed within the period PR1 of the periodic resource PR, the processor 130 generates the request indication R1, and when step S330 is performed, the request indication R1 is transmitted to the base station 900 at the same time within the period PR1 of the periodical resource PR.

In some embodiments, before processing the step S330, the processor 130 first compares whether the actual arrival time of the data D is later than the expected arrival time of the data D. When the actual arrival time of the data D is later than the expected arrival time of the data D, the processor 130 generates the request indication R1, and when the step S330 is performed, transmits and the request indication R1 is transmitted to the base station 900 at the same time within the period PR1 of the periodical resource PR.

For example, assume that the expected arrival time of the data D is the time point t1, but the actual arrival time of the data D is later than the time point t1. In this case, the data D cannot be transmitted completed within the expected period PR1 of the periodical resource PR. Therefore, the processor 130 generates the request indication R1 so as to request the additional resource ER1 from the base station 900.

Reference is made back to FIG. 3 for step S350, and reference is made to FIG. 4 together. In some embodiments, when the additional resource ER1 is not obtained, only part D1 of the data D is transmitted to the base station 900 in FIG. 1 within period PR1 of the periodical resource PR. Moreover, the part D2 of the data D that is not transmitted to the base station 900 within the period PR1 of the periodical resource PR will be transmitted to the base station 900 within the period PR2 of periodical resource PR.

However, before the period PR2 of the periodical resource PR, when the processor 130 detects that the additional resource ER1 is obtained, the processor 130 transmits part D2 of the data D to the base station 900 through the additional resource ER1.

As illustrated in FIG. 4, before the time point t2, the processor 130 detects that the additional resource ER1 is obtained, and the processor 130 transmits part D2 of the data D to the base station 900 through the additional resource ER1. Since the time point t4 of the arrival time of the additional resource ER1 is earlier than the time point t2 of the arrival time of the period PR2 of periodical resource PR, part D2 of the data D can be transmitted to the base station 900 more immediately.

In some embodiments, when the base station 900 receives the request indication R1, based on the request indication R1, the base station 900 generates the feedback message F1, and the base station 900 transmits the feedback message F1 to the communication device 100. In some embodiments, the feedback message F1 includes the dynamic configured grant or the dynamic grant. In some embodiments, the feedback message F1 includes the arrival time and the transmittable data length of the additional resource ER1.

In some embodiments, when the communication device 100 obtains the feedback message F1, the communication device 100 detects that the additional resource ER1 is obtained, and the communication device 100 transmits part D2 of the data D through additional resource ER1, in response to obtaining the additional resource ER1.

In some embodiments, the request indication R1 carries the resource label to be obtained by the communication device 100, for the base station 900 to generate at least one resource allocation based on the resource label, the base station 900 further generates the feedback message F1 according to at least one resource allocation.

For example, in some embodiments, the processor 130 of the base station 900 and the communication device 100 both stores the resource allocation table shown in table 1 below. The allocation table includes several resource labels G00 to G37. Each resource label corresponds to its own resource allocation. The resource allocation includes the transmittable data length of the additional resource.

TABLE 1

| | | | | | | | |
|---|---|---|---|---|---|---|---|
| G00 | G01 | G02 | G03 | G04 | G05 | G06 | G07 |
| G10 | G11 | G12 | G13 | G14 | G15 | G16 | G17 |
| G20 | G21 | G22 | G23 | G24 | G25 | G26 | G27 |
| G30 | G31 | G32 | G33 | G34 | G35 | G36 | G37 |

In an embodiment, according to the data length of the part D2 of the data D, the processor 130 of the communication device 100 selects the resource allocation that meets its needs from the allocation table, so as to generate the request indication R1. According to the resource label carried in the request indication R1, the base station 900 selects the appropriate resource allocation according to table 1, and the base station generates the feedback message F1 based on the selected resource allocation. The above method is suitable for dynamic configured grant or dynamic grant.

In some embodiments, the request indication R1 includes a request that enables the dynamic configured grant, for the base station 900 to adopt the dynamic configured grant.

In one embodiment, the base station 900 selects the resource allocation set by the resource label as the default resource allocation according to table 1. The request indication R1 includes a request for additional resource. According to the request indication R1, the base station 900 generates the feedback message F1 based on the default resource allocation. The above method is suitable for dynamic configured grant.

In some embodiments, the request indication R1 carries the data length of part D2 of the data D. Based on the data length in the request indication R1, the base station 900 generates at least one resource allocation, and the base station 900 generates the feedback message F1 according to at least one resource allocation.

For example, in one embodiment, the request indication R1 generated by the processor 130 of the communication device 100 includes the data length of part D2 of the data D. According to the data length of part D2 of the data D included in the request indication R1, the base station 900 selects the appropriate resource allocation according to the table 1, and the base station 900 generates the feedback message F1 based on the resource allocation. The above method is suitable for dynamic configured grant or dynamic grant.

In another embodiment, the request indication R1 generated by the processor 130 of the communication device 100 includes the data length of part D2 of the data D. According to the data length of part D2 of the data D included in the request indication R1, based on the resource schedule of the base station 900 (including the resource schedule between other communication devices), the base station 900 selects an appropriate resource allocation according to the table 1, and the base station 900 generates the feedback message F1 based on the resource allocation F1. The above method is suitable for dynamic grant.

In some embodiments, the processor 130 of the communication device 100 as shown in FIG. 2 detects that the feedback message is not received before transmitting part D2 of the data D through period PR2 of the periodical resource PR. Then, when the request indication is transmitted again with the part D2 of the data D together during the period PR2 of the periodical resource PR, in response to the base station 900 not receiving the feedback message.

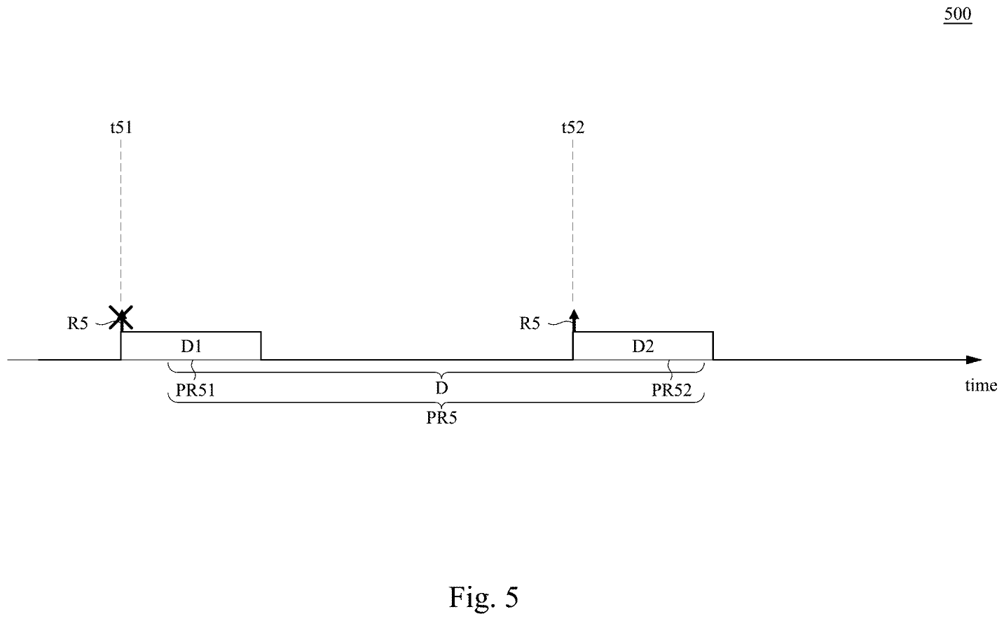

For example, reference is made to FIG. 5. FIG. 5 is a schematic diagram illustrating a data transmission situation 500 according to some embodiments of the present disclosure.

As illustrated in FIG. 5, in one embodiment, the periodical resource PR5 includes the period PR51 and the period PR52. The arrival time of the period PR51 of the periodical resource PR5 is time point t51, and the arrival time of the period PR52 of the periodical resource PR5 is time point t52.

Through the period PR51 of the periodical resource PR5, the processor 130 of the communication device 100 as illustrated in FIG. 2 transmits part D1 of the data D and the request indication R5 to the base station 900 as illustrated in FIG. 1. However, the base station 900 does not receive the request indication R5 correctly. Therefore, the base station 900 does not transmit the feedback message to the communication device 100.

The processor 130 of the communication device 100 does not receive the feedback message before the arrival time (i.e., time point t52) of period PR52 of periodical resource PR5, and the processor 130 transmits the request indication R5 again through the period PR52 of the periodical resource PR5. That is, the processor 130 transmits the request indication R5 and part D2 of the data D through the periodical resource PR5, in response to not receiving the feedback message, and the processor 130 requests the additional resource from the base station 900 again.

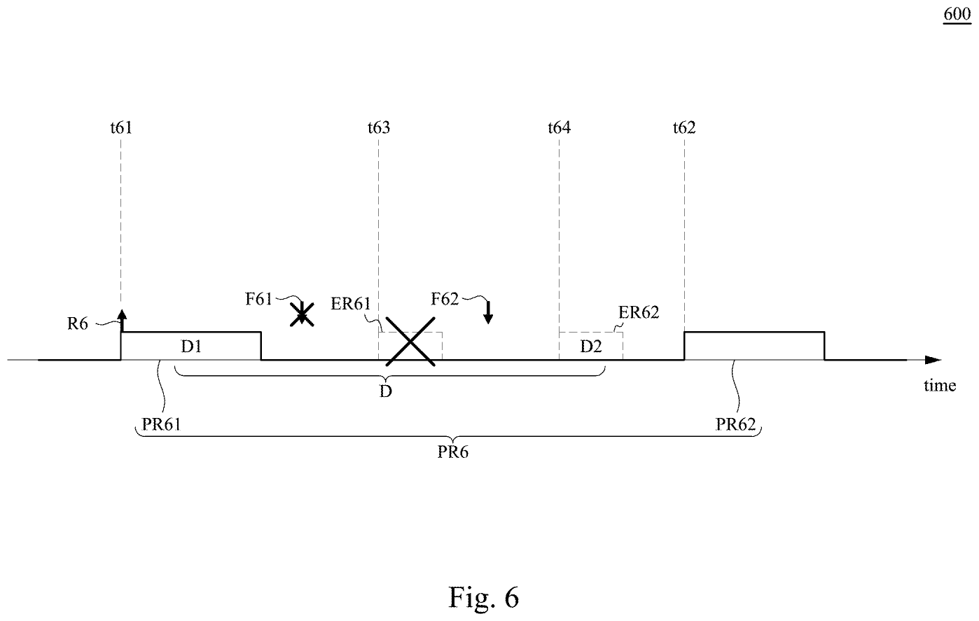

Reference is made to FIG. 6. FIG. 6 is a schematic diagram illustrating a data transmission situation 600 according to some embodiments of the present disclosure.

As illustrated in FIG. 6, in one embodiment, the periodical resource PR6 includes the period PR61 and the period PR62. The arrival time of the period PR61 of the periodical resource PR6 is time point t61, and the arrival time of the period PR62 of the periodical resource PR6 is time point t62.

Through the period PR61 of the periodical resource PR6, the processor 130 of the communication device 100 as illustrated in FIG. 2 transmits part D1 of the data D and the request indication R6 to the base station 900 as illustrated in FIG. 1. After receiving the request indication R6, the base station 900 generates the feedback message F61 to the communication device 100 based on the request indication R6. The feedback message F61 includes the arrival time of the additional resource ER61 as the time point t63 and the transmittable data length of the additional resource ER61.

However, the communication device 100 does not successfully receive the feedback message F61, so the communication device 100 does not transmit part D2 of the data D to the base station 900 at the arrival time (time point t63) of the additional resource ER61. When the base station 900 detects that communication device 100 does not transmit part D2 of the data D to the base station 900 at the arrival time of the additional resource ER61, the base station 900 generates the feedback message F62 based on the request indication R6, and the base station 900 transmits the feedback message F62 to the communication device 100. The feedback message F62 includes the arrival time of the additional resource ER62 as time point t64 and the transmittable data length of the additional resource ER62.

After successfully receiving the feedback message F62, the communication device 100 transmits part D2 of the data D to the base station 900 through the additional resource ER62.

In some embodiments, when the data length of the second part of the data is greater than the transmittable data length of the first additional resource, through the first additional resource, the second request indication is transmitted to the base station, so as to request the second additional resource from the base station according to the second request indication.

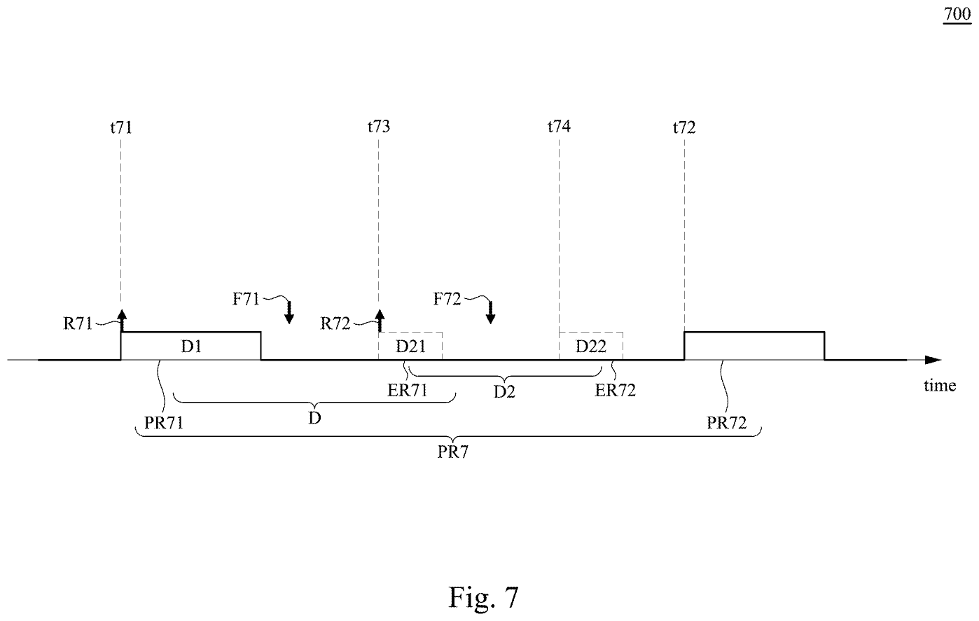

For example, reference is made to FIG. 7. FIG. 7 is a schematic diagram illustrating a data transmission situation 700 according to some embodiments of the present disclosure.

As illustrated in FIG. 7, in one embodiment, the periodical resource PR7 includes the period PR71 and the period PR72. The arrival time of the period PR71 of the periodical resource PR7 is the time point t71, and the arrival time of the period PR72 of the periodical resource PR7 is the time point t72.

Through the period PR71 of the periodical resource PR7, the processor 130 of the communication device 100 as illustrated in FIG. 2 transmits part D1 of the data D and the request indication R71 to the base station 900 as illustrated in FIG. 1. After the base station 900 receives the request indication R71, based on the request indication R71, the base station 900 generates the feedback message F71, and the base station 900 transmits the feedback message F71 to the communication device 100. The feedback message F71 includes the arrival time (e.g., time point t73) and the transmittable data length of the additional resource ER71.

In one embodiment, the processor 130 of the communication device 100 compares whether the data length of part D2 of the data D is greater than the transmittable data length of the additional resource ER71. When it is obtained that the data length of part D2 of the data D is greater than the transmittable data length of the additional resource ER71, the processor 130 of the communication device 100 transmits part D2 of the data D and the request indication R72 to the base station 900 through the additional resource ER71, so as to request another additional resource from the base station 900 according to the request indication R72.

After receiving the request indication R72, the base station 900 generates the feedback message F72 based on the request indication R72, and the base station 900 transmits the feedback message F72 to the communication device 100. The feedback message F72 includes the arrival time (e.g., time point t74) and the transmittable data length of the additional resource ER72.

Then, the processor 130 of the communication device 100 transmits part D22 of the part D2 of the data D to the base station 900 through the additional resource ER72.

In some embodiments, before transmitting the second part of the data through the periodical resource, it is detected that the first additional resource is not obtained or that the first additional resource obtained locates (e.g., is configured to be located) after the second period of the periodical resource, and requesting the first additional resource again is not required, then, the cancel indication is transmitted to the base station when transmitting the second part of the data through the periodical resource, in response to not obtaining the first additional resource or the first additional resource obtained is locating after the second period of periodical resource, and requesting the first additional resource again is not required. The cancel indication is used for cancelling the request indication.

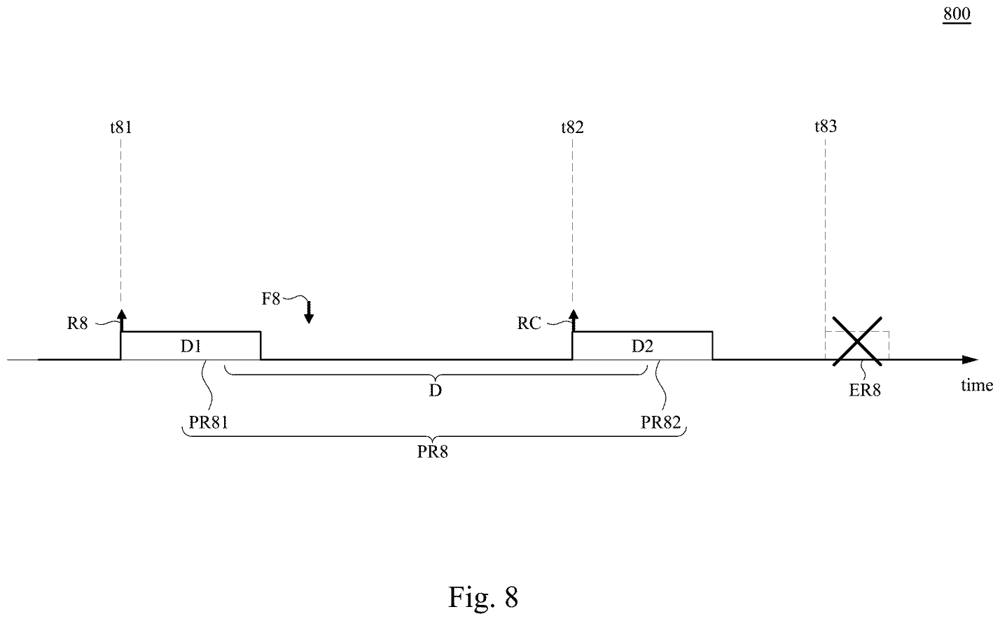

For example, Reference is made to FIG. 8. FIG. 8 is a schematic diagram illustrating a data transmission situation 800 according to some embodiments of the present disclosure.

As illustrated in FIG. 8, in one embodiment, the periodical resource PR8 includes the period PR81 and the period PR82. The arrival time of the period PR81 of the periodical resource PR8 is the time point t81, and the arrival time of the period PR82 of the periodical resource PR8 is the time point t82.

Through the period PR 81 of the periodical resource PR8, the processor 130 of the communication device 100 as illustrated in FIG. 2 transmits part D1 of the data D and the request indication R8 to the base station 900 as illustrated in FIG. 1. After the base station 900 receives the request indication R8, the base station 900 generates the feedback message F8 based on the request indication R8, and the base station transmits the feedback message F8 to the communication device 100. The feedback message F8 includes the arrival time (e.g., time point t83) and the transmittable data length of the additional resource ER8.

In one embodiment, when the arrival time (e.g., time point t83) of the additional resource ER8 locates (or falls) after the period PR82 of the periodical resource PR8, and requesting the additional resource ER8 again is not required, the processor 130 of the communication device 100 transmits part D2 of the data D and the cancel indication RC to the base station 900 through the periodical resource PR8, in response to the additional resource ER8 locating after the period PR82 of the periodical resource PR8. According to the cancel indication RC, the base station 900 cancels the additional resource ER8.

Reference is made to FIG. 5 again. In one embodiment, before the arrival time of period PR52 of the periodical resource PR5 (i.e., time point t52), the processor 130 of the communication device 100 has not obtained the additional resource and requesting the additional resource again is not required, the processor 130 of the communication device 100 transmits the cancel indication (not illustrated) to the base station 900 through the periodical resource PR5, in response to not obtaining the additional resource. According to the cancel indication, the base station 900 cancels the additional resource.

In some embodiments, the communication device 100 can be a server, a circuit, a central processing unit (CPU), a microprocessor (MCU) with functions such as storage, calculation, data reading, signals or messages receiving, signals or messages transmission, or other devices with equivalent functions. In some embodiments, the transceiver circuit 150 may be an element including signal output/input, message output/input or similar functions.

According to the embodiment of the present disclosure, it is understood that the embodiments of the present disclosure are to provide a communication device and a data transmission method. In the face of a large increase in uplink data with XR, before transmitting the periodic data with large data changes or data with changing arrival time to the base station through the periodical resource of the configured grant, the additional resource is dynamically requested. For example, the embodiments of the present disclosure generate request indication and transmit the request indication while transmitting data to the base station through the periodical resource of the configured grant, which can reduce the signal exchange between the base station and the communication device, thereby improving the resource utilization between the base station and the communication device. In addition, by transmitting data through additional resource, the flexibility of resource allocation can be increased, and the resource waste can be reduced, thereby improving resource utilization and achieving better resource usage efficiency.

In addition, the above illustrations include sequential demonstration operations, but the operations need not be performed in the order shown. The execution of the operations in a different order is within the scope of this disclosure. In the spirit and scope of the embodiments of the present disclosure, the operations may be increased, substituted, changed and/or omitted as the case may be. It will be understood that, the terms “first” and “second” are used to distinguish the same statements. These terms are not used to limit any order between the statements and are not used to limit any order between the steps involved in the statements.

The foregoing outlines features of several embodiments so that those skilled in the art may better understand the aspects of the present disclosure. Those skilled in the art should appreciate that they may readily use the present disclosure as a basis for designing or modifying other processes and structures for carrying out the same purposes and/or achieving the same advantages of the embodiments introduced herein. Those skilled in the art should also realize that such equivalent constructions do not depart from the spirit and scope of the present disclosure, and that they may make various changes, substitutions, and alterations herein without departing from the spirit and scope of the present disclosure.

What is claimed is:

1. A data transmission method, suitable for a communication device, the communication device communicatively connected to a base station, comprising:
receiving a configured grant from the base station, wherein the configured grant is used for scheduling a periodical resource, wherein the periodical resource is used for transmitting a data to the base station;
transmitting a first part of the data and a first request indication to the base station through the periodical resource, wherein the first request indication is used for requesting a first additional resource from the base station; and
detecting that the first additional resource is obtained before transmitting a second part of the data through the periodical resource, and transmitting the second part of the data to the base station through the first additional resource, in response to obtaining the first additional resource.

2. The data transmission method of claim 1, further comprising:
comparing whether a data length of the data is greater than a transmittable data length of the periodical resource within a single period; and
when obtaining that the data length of the data is greater than the transmittable data length of the periodical resource within the single period, generating the first request indication.

3. The data transmission method of claim 1, further comprising:
comparing whether an actual arrival time of the data is later than an expected arrival time of the data; and
when obtaining that the actual arrival time of the data is later than the expected arrival time of the data, generating the first request indication.

4. The data transmission method of claim 1, further comprising:
when obtaining that a data length of the second part of the data is greater than a transmittable data length of the first additional resource, transmitting a second request indication to the base station through the first additional resource, so as to request a second additional resource according to the second request indication from the base station.

5. The data transmission method of claim 1, further comprising:
receiving a feedback message transmitted by the base station based on the first request indication, wherein the feedback message comprises a dynamic configured grant or a dynamic grant, so as to indicate the first additional resource.

6. The data transmission method of claim 5, further comprising:
detecting that the feedback message is not received before transmitting the second part of the data through the periodical resource, and transmitting the first request indication again when transmitting the second part of the data through the periodical resource, in response to not receiving the feedback message.

7. The data transmission method of claim 1, wherein the first part of the data and the first request indication are transmitted through a first period of the periodical resource, wherein the data transmission method further comprises:
before transmitting the second part of the data through the periodical resource, detecting that the first additional resource is not obtained or that the first additional resource obtained locates after a second period of the periodical resource, and requesting the first additional resource again is not required, then transmitting a cancel indication to the base station when transmitting the second part of the data through the periodical resource, in response to not obtaining the first additional resource or the first additional resource obtained locating after the second period of the periodical resource, and requesting the first additional resource again is not required, wherein the cancel indication is used for cancelling the first request indication.

8. The data transmission method of claim 1, wherein the first request indication carries a data length of the second part of the data, for the base station to generate at least one resource allocation based on the data length in the first request indication, so as to generate a feedback message.

9. The data transmission method of claim 1, wherein the first request indication carries a resource label to be obtained by the communication device, for the base station to generate at least one resource allocation based on the resource label in the first request indication, so as to generate a feedback message.

10. The data transmission method of claim 1, wherein the data comprises extended reality (XR) data.

11. A communication device, comprising:
a storage circuit, configured to store a plurality of instructions; and
a processor, coupled to the storage circuit, and configured to execute the plurality of instructions to perform the following operations:
receiving a configured grant from a base station, wherein the configured grant is used for scheduling a periodical resource, wherein the periodical resource is used for transmitting a data to the base station;
transmitting a first part of the data and a first request indication to the base station through the periodical resource, wherein the first request indication is used for requesting a first additional resource from the base station; and
detecting that the first additional resource is obtained before transmitting a second part of the data through the periodical resource, and transmitting the second part of the data to the base station through the first additional resource, in response to obtaining the first additional resource.

12. The communication device of claim 11, wherein the processor is further configured to perform the following operations:
comparing whether a data length of the data is greater than a transmittable data length of the periodical resource within a single period; and
when obtaining that the data length of the data is greater than the transmittable data length of the periodical resource within the single period, generating the first request indication.

13. The communication device of claim 11, wherein the processor is further configured to perform the following operations:
comparing whether an actual arrival time of the data is later than an expected arrival time of the data; and
when obtaining that the actual arrival time of the data is later than the expected arrival time of the data, generating the first request indication.

14. The communication device of claim 11, wherein the processor is further configured to perform the following operations:
when obtaining that a data length of the second part of the data is greater than a transmittable data length of the first additional resource, transmitting a second request indication to the base station through the first additional resource, so as to request a second additional resource according to the second request indication from the base station.

15. The communication device of claim 11, wherein the processor is further configured to perform the following operations:
receiving a feedback message transmitted by the base station based on the first request indication, wherein the feedback message comprises a dynamic configured grant or a dynamic grant, so as to indicate the first additional resource.

16. The communication device of claim 15, wherein the processor is further configured to perform the following operations:
detecting that the feedback message is not received before transmitting the second part of the data through the periodical resource, and transmitting the first request indication again when transmitting the second part of the data through the periodical resource, in response to not receiving the feedback message.

17. The communication device of claim 11, wherein the first part of the data and the first request indication are transmitted through a first period of the periodical resource, wherein the processor is further configured to perform the following operation:
before transmitting the second part of the data through the periodical resource, detecting that the first additional resource is not obtained or that the first additional resource obtained locates after a second period of the periodical resource, and requesting the first additional resource again is not required, then transmitting a cancel indication to the base station when transmitting the second part of the data through the periodical resource, in response to not obtaining the first additional resource or the first additional resource obtained locating after the second period of the periodical resource, and requesting the first additional resource again is not required, wherein the cancel indication is used for cancelling the first request indication.

18. The communication device of claim 11, wherein the first request indication carries a data length of the second part of the data, for the base station to generate at least one resource allocation based on the data length in the first request indication, so as to generate a feedback message.

19. The communication device of claim 11, wherein the first request indication carries a resource label to be obtained by the communication device, for the base station to generate at least one resource allocation based on the resource label in the first request indication, so as to generate a feedback message.

20. The communication device of claim 11, wherein the data comprises XR data.
